(19) United States
(12) Patent Application Publication
(10) Pub. No.: US 2026/0049525 A1
(43) Pub. Date: Feb. 19, 2026

(54) BLIND WITHOUT PULL CORD AND RAISING DEVICE

(71) Applicant: FRESH SPRING INTERNATIONAL,INC., Sanchong Dist (TW)

(72) Inventor: Chih-Ming HSIEH, New Taipei City (TW)

(21) Appl. No.: 18/915,181

(22) Filed: Oct. 14, 2024

(30) Foreign Application Priority Data
Aug. 14, 2024 (TW) 113130510

(51) Int. Cl. E06B 9/324; E06B 9/322

(52) U.S. Cl. CPC E06B 9/324; E06B 9/322; E06B 2009/3222; E06B 2009/3225

(57) ABSTRACT

A blind without pull cord and a raising device configured to be connected to a movable side of a blind structure and including a housing, a retracting component, a resistance adjusting component and a raising cord. The resistance adjusting component includes a first rod and a second rod. The first rod is disposed on the housing. The second rod is movably disposed on the housing so as to be moved toward or away from the first rod. The retracting component is configured to raise or lower the movable side via the raising cord. The raising cord is in contact with the first rod and the second rod. When an end of the raising cord connected to the blind structure is pulled, the second rod is moved toward the first rod to allow the raising cord to be subjected to a greater resistance when being pulled.

### CROSS-REFERENCE TO RELATED APPLICATIONS

This non-provisional application claims priority under 35 U.S.C. § 119(a) on Patent Application No(s). 113130510 filed in Taiwan, R.O.C. on Aug. 14, 2024, the entire contents of which are hereby incorporated by reference.

### TECHNICAL FIELD

The disclosure relates to a blind, more particularly to a blind without pull cord and a raising device.

### BACKGROUND

In general, in order to meet the safety standard, most of the blind have excluded the pull cord, and multiple slats of the blind are raised/lowered by a raising device including a raising cord connecting the slats.

However, when the slats of the blind are lowered, a part of the raising cord exposed from a space between adjacent slats may be unexpectedly pulled. If a significant part of the raising cord is pulled out from that space, there will be a safe issue and the blind may not meet the safety standard. Thus, in order to allow the blind to meet the safety standard, a mechanism for preventing a significant part of the raising cord from being pulled is required.

### SUMMARY

The disclosure provides a blind without pull cord and a raising device including a resistance adjusting component preventing the safety issue caused by the raising cord by allowing the raising cord to be subjected to a greater resistance when being pulled.

One embodiment of this disclosure provides a blind without pull cord including a blind structure and at least one raising device. The blind structure has a fixed side and a movable side opposite to each other. The at least one raising device includes a housing, a retracting component, a resistance adjusting component and a raising cord. The housing is connected to the fixed side. The retracting component is rotatably disposed in the housing. The resistance adjusting component includes a first rod and a second rod. The first rod is disposed on the housing. The second rod is movably disposed on the housing so as to be configured to be moved toward or away from the first rod. Two opposite ends of the raising cord are connected to the blind structure and the retracting component, respectively. The raising cord is wound on the retracting component. The retracting component is configured to raise or lower the movable side via the raising cord. The raising cord is in contact with the first rod and the second rod. When an end of the raising cord connected to the blind structure is pulled, the second rod is moved toward the first rod to allow the raising cord to be subjected to a greater resistance when being pulled.

Another embodiment of this disclosure provides a raising device configured to be connected to a movable side of a blind structure and including a housing, a retracting component, a resistance adjusting component and a raising cord. The retracting component is rotatably disposed in the housing. The resistance adjusting component includes a first rod and a second rod. The first rod is disposed on the housing. The second rod is movably disposed on the housing so as to be configured to be moved toward or away from the first rod. Two opposite ends of the raising cord are connected to the blind structure and the retracting component, respectively. The raising cord is wound on the retracting component. The retracting component is configured to raise or lower the movable side via the raising cord. The raising cord is in contact with the first rod and the second rod. When an end of the raising cord connected to the blind structure is pulled, the second rod is moved toward the first rod to allow the raising cord to be subjected to a greater resistance when being pulled.

According to the blind and the raising device disclosed by above embodiments, the second rod is movably disposed on the housing to be configured to be moved toward or away from the first rod, and the raising cord is in contact with the first rod and the second rod. Thus, when the end of the raising cord connected the blind structure is pulled, the second rod is moved toward the first rod. In this way, the raising cord is subjected to a greater resistance when being pulled, thereby preventing a significant part of the raising cord from being pulled. Therefore, the safety issue caused by the raising cord is prevented and thus the blind is allowed to meet the safety standard.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a partially enlarged front view of a blind according to one embodiment of the disclosure whose slats are raised;

FIG. 2 is a perspective view of a raising device of the blind in FIG. 1;

FIG. 3 is an exploded view of the raising device in FIG. 2;

FIG. 4 is a partially enlarged exploded view of the raising device in FIG. 2 from another viewing angle;

FIG. 5 is a cross-sectional view showing that a first rod and a second rod of a resistance adjusting component of the raising device in FIG. 2 are located away from each other;

FIG. 6 is a partially enlarged front view of the blind in FIG. 1 whose slats are lowered;

FIG. 7 is a front view showing that a raising cord of the raising device of the blind in FIG. 1 is pulled; and

FIG. 8 is a cross-sectional view showing that the first rod and the second rod of the resistance adjusting component of the raising device in FIG. 2 are located close to each other

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

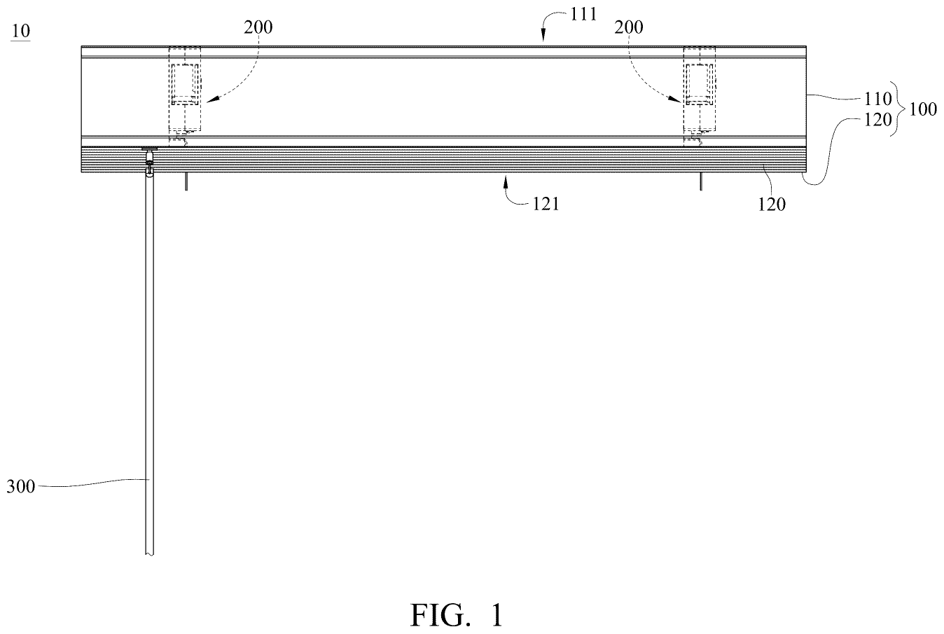

Please refer to FIG. 1 that is a partially enlarged front view of a blind 10 according to one embodiment of the disclosure whose slats 120 are raised. In this embodiment, the blind 10 includes, for example, a blind structure 100 and a plurality of raising devices 200 but does not include any pull cord. Thus, the blind 10 may be referred as a blind without pulling cord. The blind structure 100 includes a headrail 110 and a plurality of slats 120. The slats 120 are located on a side of the headrail 110. The headrail 110 has a fixed side 111. The slats 120 has a movable side 121. The fixed side 111 and the movable side 121 are opposite to each other. Specifically, the movable side 121 is, for example, a side of the slats 120 located away from the headrail 110, and the fixed side 111 is, for example, a side of the headrail 110 located away from the slats 120. In addition, the blind 10 may further include an angle adjusting rod 300. The angle adjusting rod 300 is configured to, for example, adjust the angle of each slat 120 by an angle adjusting device (not shown) disposed in the headrail 110.

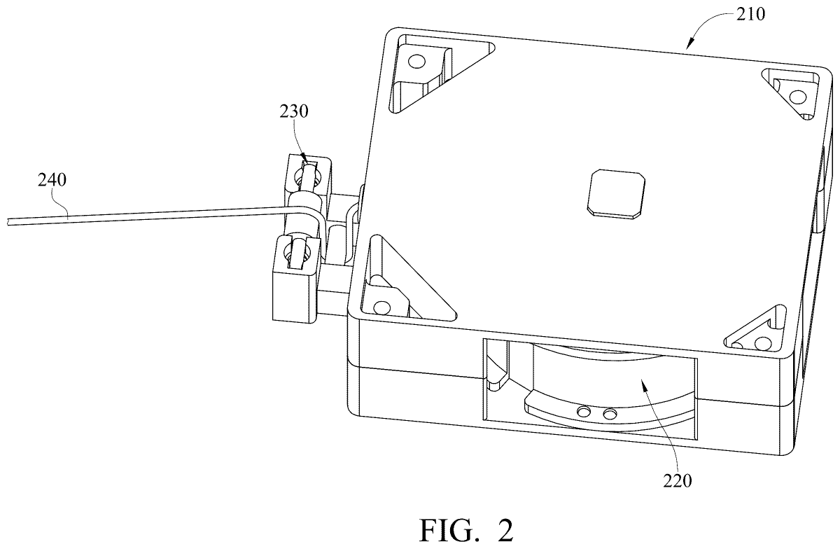

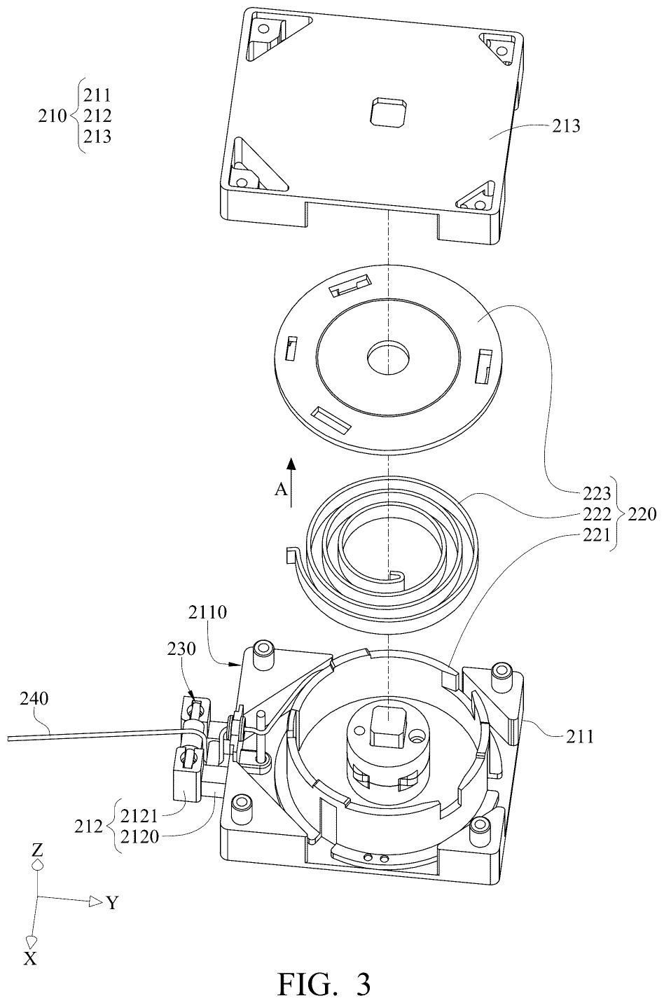

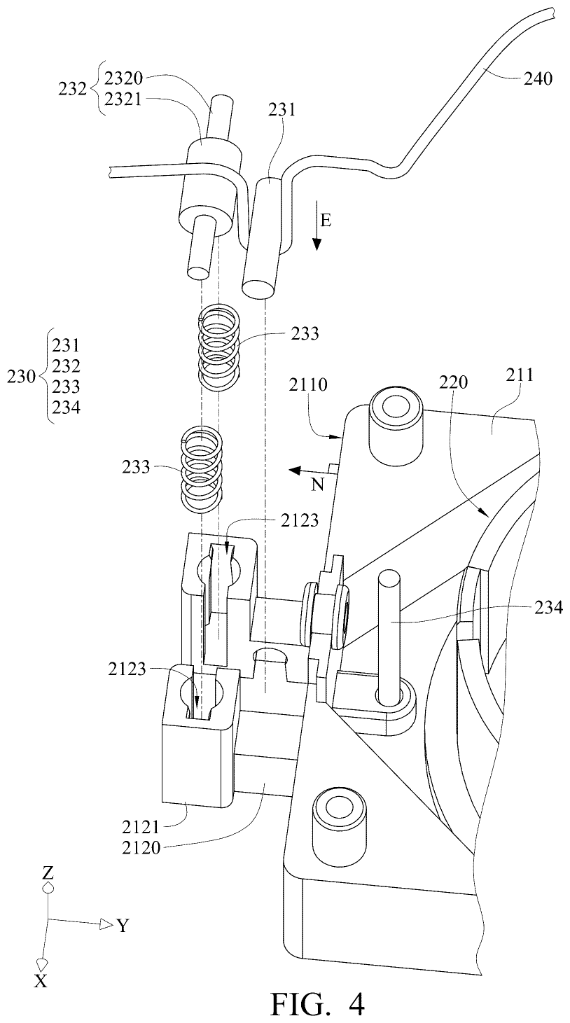

Please refer to FIGS. 1 to 4. FIG. 2 is a perspective view of the raising device 200 of the blind 10 in FIG. 1. FIG. 3 is an exploded view of the raising device 200 in FIG. 2. FIG. 4 is a partially enlarged exploded view of the raising device 200 in FIG. 2 from another viewing angle. In this embodiment, the raising devices 200 are disposed in the headrail 110 and are spaced apart from each other. The raising devices 200 have similar structures, and thus one raising device 200 will be exemplarily described in detail hereinafter.

In this embodiment, the raising device 200 includes, for example, a housing 210, a retracting component 220, a resistance adjusting component 230 and a raising cord 240. In this embodiment, the housing 210 is disposed in the headrail 110, and includes, for example, a base 211, a mounting protrusion 212 and a cover 213. The mounting protrusion 212 includes a first mounting part 2120 and a second mounting part 2121. The first mounting part 2120 protrudes from a side of the base 211. The second mounting part 2121 protrudes from a side of the first mounting part 2120 located away from the base 211. The cover 213 is disposed on a side of the base 211.

The retracting component 220 is rotatably disposed in the housing 210. In detail, the retracting component 220 includes, for example, a barrel 221 and an elastic plate 222 that is in a spiral shape. The barrel 221 is rotatably disposed in the base 211, and two opposite ends of the elastic plate 222 are fixed to the base 211 and the barrel 221, respectively. In addition, in this embodiment, the elastic plate 222 includes, for example, a first elastic state and a second elastic state. A restoring force (first restoring force) generated by the elastic plate 222 in the first elastic state is greater than a restoring force (second restoring force) generated by the elastic plate 222 in the second elastic state. Specifically, the first restoring force is much greater than the second restoring force. For example, during the unwinding process of the elastic plate 222 (i.e., when the elastic plate 222 is changed from a totally wound state to a totally unwound state), the elastic plate 222 is changed from the second elastic state to the first elastic state, and then is changed from the first elastic state to the second elastic state. Moreover, the retracting component 220 may further include a covering plate 223 disposed on a side of the barrel 221 located away from the base 211 to cover the elastic plate 222.

In addition, since the raising device 200 is disposed in the headrail 110 having larger accommodation space, the design flexibility of the elastic plate 222 is improved. That is, when a greater restoring force is required to be generated by the elastic plate 222 and thus the elastic plate 222 is required to have larger size, the accommodation space of the headrail 110 is still large enough to accommodate the raising device 200 whose size is increased with the size of the elastic plate 222.

As shown in FIGS. 3 and 4, the resistance adjusting component 230 includes a first rod 231, a second rod 232, two elastic components 233 and a third rod 234. The first rod 231 is rotatably disposed on, for example, the first mounting part 2120. The second rod 232 is slidably disposed in two slide grooves 2123 of the second mounting part 2121 via the elastic components 233 so as to be moved toward or away from the first rod 231. In this embodiment, the second rod 232 includes, for example, an inner rod part 2320 and an outer rod part 2321. The outer rod part 2321 is fixed to the inner rod part 2320, or rotatably disposed on the inner rod part 2320. The outer rod part 2321 rests on an end of each elastic component 233. The third rod 234 stands on the base 211, and is located in the housing 210. In other embodiments, the resistance adjusting component may include one elastic component.

As shown in FIGS. 1, 3 and 4, two opposite ends of the raising cord 240 are connected to the blind structure 100 and the retracting component 220, respectively. In detail, an end of the raising cord 240 is wound on the retracting component 220, and the other end of the raising cord 240 connects the slats 120 so as to allow the slats 120 to be located on a side of the headrail 110. The raising cord 240 is in contact with the first rod 231, the outer rod part 2321 of the second rod 232 and the third rod 234.

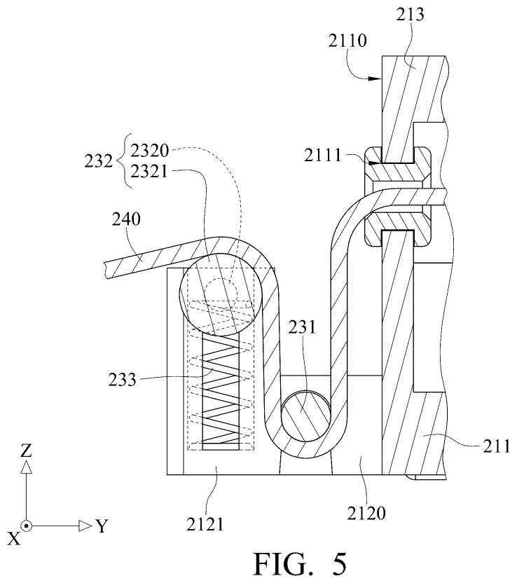

Please refer to FIGS. 3 to 5. FIG. 5 is a cross-sectional view showing that the first rod 231 and the second rod 232 of the resistance adjusting component 230 of the raising device 200 in FIG. 2 are located away from each other. In this embodiment, the outer surface 2110 of the housing 210 may have, for example, a cord hole 2111. The outer surface 2110 and the cord hole 2111 may be together formed by the base 211 and the cover 213. The raising cord 240 is disposed through the cord hole 2111. An extension direction E of the first rod 231 and the second rod 232 (e.g., a direction parallel to X-axis direction) is perpendicular to an axial direction A of the retracting component 220 (e.g., a direction parallel to Z-axis direction) and a normal direction N of the outer surface 2110 (e.g., a direction parallel to Y-axis direction). That is, in this embodiment, the first rod 231 and the second rod 232 are arranged in a horizontal manner. Thus, the raising cord 240 is facilitated to be wound on the first rod 231 and the second rod 232 and bent down toward the slats 120 (as shown in FIG. 1). However, the disclosure is not limited thereto. In other embodiments, the first rod and the second rod may be arranged in a vertical manner. That is, the extension direction of the first rod and the second rod may be parallel to Z-axis direction.

In addition, as shown in FIGS. 1 and 3, when the slats 120 are totally raised on a side of the headrail 110 as shown in FIG. 1, the elastic plate 222 is in the first elastic state. That is, the end of the raising cord 240 located away from the retracting component 220 is previously pulled to allow the elastic plate 222 to be previously changed from the second elastic state to the first elastic state, thereby ensuring the restoring force generated by the elastic plate 222 is great enough to raise the slats 120.

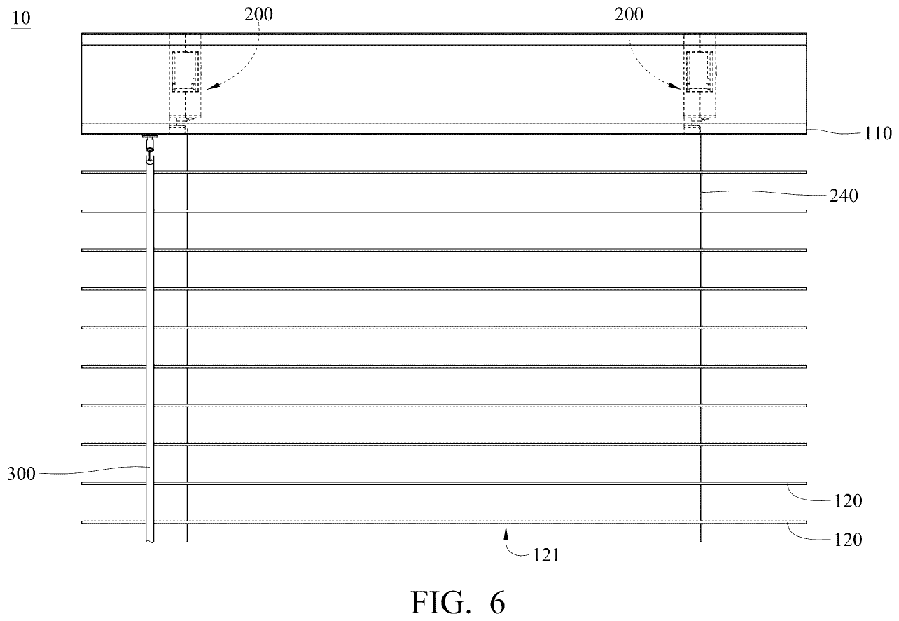

Please refer to FIGS. 3, 4 and 6. FIG. 6 is a partially enlarged front view of the blind 10 in FIG. 1 whose slats 120 are lowered. The retracting component 220 is configured to raise/lower the movable side 121 via the raising cord 240. Hereinafter, the principle for holding or raising/lowering the slats 120 will be described. First, the principle for holding the slats 120 is any desired position will be described. When the slats 120 is stopped being moved, the raising cord 240 is pulled by the restoring force generated by the elastic plate 222, the weight of the slats 120 and the static friction (smaller than or equal to the stiction) generated between the raising cord 240 and other components (e.g., the second rod 232 and the third rod 234). When the slats 120 is lowered to different positions, the pulling force applied on the raising cord 240 by the weight of the slats 120 changes, and thus the said static friction is changed corresponding. In this way, the raising cord 240 is at a static equilibrium since the restoring force of the elastic plate 222 is balanced by the weight of the slats 120 and the static friction applied on the raising cord 240. Thus, the slats 120 are allowed to be held in any desired position by the aforementioned static equilibrium of the raising cord 240. For example, when the movable side 121 is pulled away from the headrail 110 and then is stopped being pulled, the pulling force applied on the raising cord 240 by the weight of the slats 120 is decreased, but the static friction between the raising cord 240 and other components (e.g., the second rod 232 and the third rod 234) is increased without exceeding the stiction, and thus the restoring force generated by the elastic plate 222 is balanced; when the movable side 121 is pulled toward the headrail 110 and then is stopped being pulled, the pulling force applied on the raising cord 240 by the weight of the slats 120 is increased, but the static friction between the raising cord 240 and other components (e.g., the second rod 232 and the third rod 234) is decreased, and thus the restoring force generated by the elastic plate 222 is balanced.

Also, when the slats 120 are totally lowered on a side of the headrail 110 as shown in FIG. 6, the elastic plate 222 is in the second elastic state. That is, when the slats 120 are totally lowered, the restoring force generated by the elastic plate 222 is small. Although the pulling force applied on the raising cord 240 by the weight of the slats 120 is very small when the slats 120 are totally lowered, the restoring force generated by the elastic plate 222 is still allowed to be balanced due to the significant decrease of the restoring force generated by the elastic plate 222. That is, the aforementioned design of the elastic state enables the slats 120 to be maintained at the totally lowered state.

Hereinafter, the principle for raising/lowering the slats 120 will be described. When the slats 120 are required to be lowered or raised, the slats 120 may be moved away from or toward the headrail 110, and thus the raising cord 240 is no longer at the static equilibrium, thereby allowing the slats 120 to be moved away from or close to the headrail 110 to be lowered or raised. Specifically, when the slats 120 are moved away from or close to the headrail 110, the raising cord 240 is no longer at the static equilibrium since the stiction between the raising cord 240 and other components is overcome by the force applied on the slats 120 and a dynamic friction (smaller than the stiction) therebetween is generated.

Note that in this embodiment, the third rod 234 is configured to increase the friction (resistance) applied on the raising cord 240. In other embodiments, the resistance adjusting component may not include the third rod 234, and the static equilibrium may be achieved by adjusting the restoring force generated by the elastic plate.

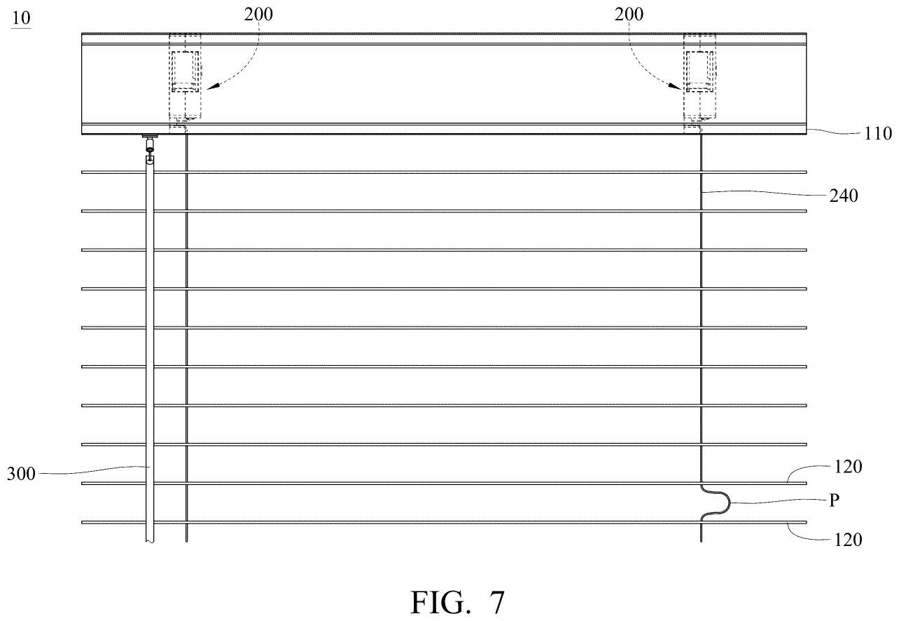

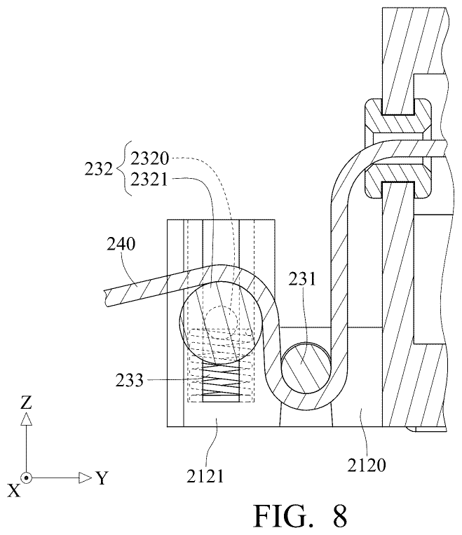

Please refer to FIGS. 5, 7 and 8. FIG. 7 is a front view showing that the raising cord 240 of the raising device 200 of the blind 10 in FIG. 1 is pulled. FIG. 8 is a cross-sectional view showing that the first rod 231 and the second rod 232 of the resistance adjusting component 230 of the raising device 200 in FIG. 2 are located close to each other. When the end of the raising cord 240 connecting the slats 1220 (e.g., a part P of the raising cord 240 exposed from a space between adjacent slats 120) is pulled, the second rod 232 is moved toward the first rod 231 along, for example, negative Z-axis direction, which tightens the raising cord 240 by the second rod 232 and the first rod 231 (i.e., increases the tension on the raising cord 240). Therefore, a normal force applied by the raising cord 240 to other component (e.g., the second rod 232) is increased, thereby increasing the dynamic friction generated between the raising cord 240 and other component (e.g., the second rod 232). In this way, the raising cord 240 is subjected to a greater resistance when being pulled, thereby preventing a significant part of the raising cord 240 from being pulled out of the space between adjacent slats 120. Also, when the end of the raising cord 240 connecting the slats 120 is subjected to a greater pulling force, the second rod 232 is moved to be closer to the first rod 231, thereby further increasing the resistance applied on the raising cord 240. In other words, by moving the second rod 232 toward the first rod 231, the resistance applied on the raising cord 240 is increased with the pulling force applied on the end of the raising cord 240 connecting slats 120.

Note that during the lowering process of the slats 120, the second rod 232 is slightly moved toward the first rod 231, but is not significantly moved toward the first rod 231 as shown in FIG. 8. Thus, during the lowering process of the slats 120, the raising cord 240 is not subjected to a great resistance as in the state shown in FIG. 8.

In addition, the disclosure is not limited by the number and the size of the slats 120. In other embodiments, the number and the size of the slats may be adjusted based on the magnitude of the restoring force generated by the elastic plate as long as the slats are allowed to be held at any desired position.

Furthermore, the disclosure is not limited by the number of the raising devices 200. In other embodiments, the blind may include one raising device. Also, in other embodiments where the blind includes multiple raising devices, one raising device may include the resistance adjusting component, and other raising devices may not include the resistance adjusting component.

According to the blind and the raising device disclosed by above embodiments, the second rod is movably disposed on the housing to be configured to be moved toward or away from the first rod, and the raising cord is in contact with the first rod and the second rod. Thus, when the end of the raising cord connected the blind structure is pulled, the second rod is moved toward the first rod. In this way, the raising cord is subjected to a greater resistance when being pulled, thereby preventing a significant part of the raising cord from being pulled. Therefore, the safety issue caused by the raising cord is prevented and thus the blind is allowed to meet the safety standard.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A blind without pull cord, comprising:
a blind structure, having a fixed side and a movable side opposite to each other; and
at least one raising device, comprising:
a housing, connected to the fixed side;
a retracting component, rotatably disposed in the housing;
a resistance adjusting component, comprising a first rod and a second rod, wherein the first rod is disposed on the housing, and the second rod is movably disposed on the housing so as to be configured to be moved toward or away from the first rod; and
a raising cord, wherein two opposite ends of the raising cord are connected to the blind structure and the retracting component, respectively, the raising cord is wound on the retracting component, the retracting component is configured to raise or lower the movable side via the raising cord, the raising cord is in contact with the first rod and the second rod, and when an end of the raising cord connected to the blind structure is pulled, the second rod is moved toward the first rod to allow the raising cord to be subjected to a greater resistance when being pulled.

2. The blind without pull cord according to claim 1, wherein the blind structure comprises a headrail and a plurality of slats, the housing is disposed in the headrail, the raising cord connects the plurality of slats so as to allow the plurality of slats to be located on a side of the headrail, and the fixed side and the movable side are located on the headrail and the slats, respectively.

3. The blind without pull cord according to claim 2, wherein the retracting component comprises a barrel and an elastic plate that is in a spiral shape, the barrel is rotatably disposed in the housing, two opposite ends of the elastic plate are fixed to the housing and the barrel, respectively, and the raising cord is wound on the barrel.

4. The blind without pull cord according to claim 3, wherein the elastic plate comprises a first elastic state and a second elastic state, and a restoring force generated by the elastic plate in the first elastic state is greater than a restoring force generated by the elastic plate in the second elastic state.

5. The blind without pull cord according to claim 4, wherein when the plurality of slats are totally raised on a side of the headrail, the elastic plate is in the first elastic state.

6. The blind without pull cord according to claim 4, wherein when the plurality of slats are totally lowered on a side of the headrail, the elastic plate is in the second elastic state

7. A raising device, configured to be connected to a movable side of a blind structure, the raising device comprising:
a housing;
a retracting component, rotatably disposed in the housing;
a resistance adjusting component, comprising a first rod and a second rod, wherein the first rod is disposed on the housing, and the second rod is movably disposed on the housing so as to be configured to be moved toward or away from the first rod; and
a raising cord, wherein two opposite ends of the raising cord are connected to the blind structure and the retracting component, respectively, the raising cord is wound on the retracting component, the retracting component is configured to raise or lower the movable side via the raising cord, the raising cord is in contact with the first rod and the second rod, and when an end of the raising cord connected to the blind structure is pulled, the second rod is moved toward the first rod to allow the raising cord to be subjected to a greater resistance when being pulled.

8. The raising device according to claim 7, wherein the housing comprises a base and a mounting protrusion, the resistance adjusting component further comprises at least one elastic component, the mounting protrusion comprises a first mounting part and a second mounting part, the first mounting part protrudes from a side of the base, the second mounting part protrudes from a side of the first mounting part located away from the base, the retracting component is rotatably disposed in the base, the first rod is rotatably disposed on the first mounting part, and the second rod is slidably disposed on the second mounting part via the at least one elastic component.

9. The raising device according to claim 7, wherein the resistance adjusting component further comprises a third rod disposed in the housing and in contact with the raising cord.

10. The raising device according to claim 7, wherein an outer surface of the housing has a cord hole, the raising cord is disposed through the cord hole, an extension direction of the first rod and the second rod is perpendicular to an axial direction of the retracting component and a normal direction of the outer surface.
